(19) United States
(12) Patent Application Publication
(10) Pub. No.: US 2011/0054125 A1
(43) Pub. Date: Mar. 3, 2011

(54) CURABLE COMPOSITION AND USE THEREOF

(76) Inventor: JIE YAO, Shanghai (CN)

(21) Appl. No.: 12/942,346

(22) Filed: Nov. 9, 2010

Related U.S. Application Data
(63) Continuation of application No. PCT/CN2008/000938, filed on May 14, 2008.

(51) Int. Cl. C08L 63/02

(52) U.S. Cl. 525/523

(57) ABSTRACT

This invention relates to a curable composition comprising one or more of organic metal compounds as crosslinker and its application in semiconductor packages. Particularly, the organic metal compound is an organic titanate. In some embodiments, the organic titanates include, but are not limited to tetraalkyl titanates and titanate chelates. The curable composition has an increased crosslinking density and shows high storage modulus at elevated temperature without bringing significant increase of room temperature modulus, which makes the curable composition potentially have high performance during reliability test for semiconductor packages.

### CROSS-REFERENCE TO RELATED APPLICATION

This application is a continuation of International Application No. PCT/CN2008/000938 filed May 14, 2008, the contents of which is incorporated herein by reference.

### FIELD OF THE INVENTION

The present invention generally relates to a curable composition comprising an organic metal compound as a crosslinker, and particularly to a curable composition for use in the semiconductor packaging industry.

### BACKGROUND OF THE INVENTION

Die attach material is mostly polymer based, and mostly amorphous polymer. One of the most important characteristics of amorphous polymer material is that it will experience glass transition with temperature changes. Very large change in modulus will take place over a fairly restricted temperature range, which is defined as glass transition temperature. Modulus measures the resistance to deformation of a material when an external force is applied. Die shear strength is basically a measure of resistance of die attach material to shear force. Therefore die shear strength is related to modulus, and modulus experiences large change at range of glass transition temperature. According to die attach product development experiences, hot die shear strength are related to material modulus at elevated temperature. Normally, the storage modulus of a die attach material decreases quickly at glass transition range, and finally the retained storage modulus at elevated temperature, after glass transition, is very low. This may result in poor reliability performance of the material.

To balance a moderate modulus at room temperature with retention at high temperature is desirable to meet reliability requirement. In the past, effort to increase modulus at elevated temperature most often was accompanied by increase of modulus at room temperature, which introduces stress increase in packages.

Therefore, there is still a need in the art for a curable composition with high storage modulus at elevated temperature without significant increase of room temperature modulus.

### SUMMARY OF THE INVENTION

This invention is a curable composition comprising at least a resin and an organic metal compound as a crosslinker to obtain high storage modulus at elevated temperature while not bringing significant increase of room temperature modulus. Organic metal compounds, such as organic titanates, if added into the curable composition, such as die attach materials, underfill, and the like, will react both with the polymer and the filler, which thereby makes a connection between the two, increasing the cross-linking density of the system.

In the present invention, a curable composition comprising an organic metal compound as a crosslinker, a method for increasing cross-linking density of a curable composition, the use of the organic metal compound as a crosslinker, and the article produced by using the said curable composition are disclosed. Particularly, the present invention includes, but not limited to, embodiments as follows.
1. A curable composition comprising a resin and an organic metal compound as a crosslinker.
2. The curable composition as described in embodiment 1, wherein the organic metal compound is selected from the group consisting of organic titanium compound, organic aluminum compound, organic zirconium compound and combinations thereof.
3. The curable composition as described in embodiment 2, wherein the organic titanium compound comprises an organic titanate and/or a titanium chelate.
4. The curable composition as described in embodiment 3, wherein the organic titanate is selected from the group consisting of tetrakis(2-ethylhexyl)titanate, tetraisopropyl titanate, tetra-n-butyl titanate and combinations thereof.
5. The curable composition as described in embodiment 3, wherein the titanium che late is selected from the group consisting of acetylacetonate titanate chelate, ethyl acetoacetate titanate chelate, triethanolamine titanate chelate, lactic acid titanate chelate and combinations thereof.
6. The curable composition as described in embodiment 2, wherein the organic aluminum compound comprises distearoyl isopropoxy aluminate.
7. The curable composition as described in embodiment 2, wherein the organic zirconium compound is selected from the group consisting of tetraalkyl zirconate, tetra-n-propyl zirconate, tetrakis(triethanloamino)zirconium(IV), sodium zirconium lactate, zirconium tetra-n-butanolate, and bis-citric acid diethyl ester n-propanolate zirconium chelate.
8. The curable composition as described in any one of preceding embodiments, wherein the crosslinker is present at an amount from about 0.1 wt % to about 15 wt %, based on the total weight of the composition.
9. The curable composition as described in embodiment 8, wherein the crosslinker is present at an amount from about 0.5 wt % to about 10 wt %, based on the total weight of the composition.
10. The curable composition as described in embodiment 9, wherein the crosslinker is present at an amount from about 1.0 wt % to about 6 wt %, based on the total weight of the composition.
11. The curable composition as described in embodiment 10, wherein the crosslinker is present at an amount from about 2 wt % to about 4 wt %, based on the total weight of the composition.
12. The curable composition as described in any of preceding embodiments, wherein the resin is selected from one or more of an epoxy, acrylic ester, methacrylic ester, maleimide, vinyl ether, vinyl, cyanate ester, or siloxane resin.
13. The curable composition as described in any one of preceding embodiments further comprises one or more of filler, diluent and curing agent.
14. The curable composition as described in embodiment 13, wherein the filler is selected from one or more of gold, silver, copper, nickel, iron, alloys of these; copper, nickel, iron, glass, silica, aluminum, or stainless steel coated with gold, silver, or copper; aluminum, stainless steel; silica, glass, silicon carbide, boron nitride, aluminum oxide, boric-acid aluminum, aluminum nitride, oxide filler, and metal coated oxide filler.
15. The curable composition as described in embodiment 13, wherein the curing agent is selected from one or more of Lewis acid, Lewis base, imidazole, anhydride, amine, and amine adduct.
16. The curable composition as described in any one of embodiments 13-15, wherein the total loading of one or more of the resins falls into the range from about 10-85 wt %, about 20-70 wt %, or about 20-50 wt %, based on the total weight of the curable composition.
17. The curable composition as described in any one of embodiments 13-15, wherein the total loading of one or more of the fillers is in a range from about 10 wt % to about 85 wt %, about 30 wt % to about 70 wt %, or about 40 wt % to about 60 wt %, based on the total weight of the curable composition.
18. The curable composition as described in any one of embodiments 13-15, wherein the total loading of one or more of the curing agents is in a range from about 0.1 wt % to about 10 wt %, or about 1 wt % to about 5 wt %, based on the total weight of the curable composition.
19. The curable composition as described in any one of preceding embodiments, wherein the curable composition is a die attach adhesive or an underfill encapsulant.
20. The use of an organic metal compound as a crosslinker in a curable composition.
21. The use as described in embodiment 20, wherein the organic metal compound is selected from the group consisting of organic titanium compound, organic aluminum compound, organic zirconium compound and combinations thereof.
22. The use as described in embodiment 21, wherein the organic titanium compound comprises an organic titanate and/or titanium chelate.
23. The use as described in embodiment 22, wherein the organic titanate is selected from the group consisting of tetrakis(2-ethylhexyl)titanate, tetraisopropyl titanate, tetra-n-butyl titanate and combinations thereof.
24. The use as described in embodiment 22, wherein the titanium chelate is selected from the group consisting of acetylacetonate titanate chelate, ethyl acetoacetate titanate chelate, triethanolamine titanate chelate, lactic acid titanate chelate and combinations thereof.
25. The use as described in embodiment 21, wherein the organic aluminum compound comprises distearoyl isopropoxy aluminate.
26. The use as described in embodiment 21, wherein the organic zirconium compound is selected from the group consisting of tetraalkyl zirconate, tetra-n-propyl zirconate, tetrakis(triethanloamino)zirconium(IV), sodium zirconium lactate, zirconium tetra-n-butanolate, and bis-citric acid diethyl ester n-propanolate zirconium chelate.
27. The use as described in any one of embodiments 20-26, wherein the organic metal compound is present at an amount of from about 0.1 wt % to about 15 wt %, based on the weight of the curable composition.
28. The use as described in embodiment 27, wherein the organic metal compound is present at an amount of from about 0.5 wt % to about 10 wt %, based on the weight of the curable composition.
29. The use as described in embodiment 28, wherein the organic metal compound is present at an amount of from about 1.0 wt % to about 6.0 wt %, based on the weight of the curable composition.
30. The use as described in embodiment 29, wherein the organic metal compound is present at an amount of from about 2 wt % to about 4 wt %, based on the weight of the curable composition.
31. A method for increasing the crosslinking density in a curable composition, the method comprising adding an effective amount of an organic metal compound as a crosslinker to the curable composition.
32. The method as described in embodiment 31, wherein the organic metal compound is selected from the group consisting of organic titanium compound, organic aluminum compound, organic zirconium compound and combination thereof.
33. The method as described in embodiment 31 or 32, wherein the total amount of the organic metal compounds is in the range from about 0.1 wt % to about 15 wt %, preferably from about 0.5 wt % to about 10 wt %, more preferably from about 1.0 wt % to about 6.0 wt %, and still more preferably from about 2 wt % to about 6 wt %, based on the total weight of the curable composition.
34. A method for producing an article with a component bonded to a substrate, the method comprising applying the curable composition as described in any one of embodiments 1-19 onto at least a part of the substrate surface and the component, and bonding the component to the substrate surface, and optionally thermally curing the curable composition at a temperature above room temperature after contacting the substrate with the adhesive.
35. An article produced by using the curable composition as described in embodiments 1-19, the article comprising a substrate, a component on the substrate and the curable composition.

Due to the use of organic metal compounds as a crosslinker in the present invention, which may react both with resin and filler, the crosslinking density of the adhesive system may be improved. Further, the curable composition of the present invention may show high storage modulus at elevated temperature while not bringing significant increase of room temperature modulus.

### DETAILED DESCRIPTION OF THE INVENTION

Unless defined otherwise herein, all technical and scientific terms used herein have the same meaning as commonly understood by one of ordinary skill in the art to which this invention pertains. Although any methods and materials similar or equivalent to those described herein may find use in the practice of the present invention, the preferred methods and materials are described herein. Accordingly, the terms defined immediately below are more fully described by reference to the Specification as a whole. Also, as used herein, the singular “a”, “an” and “the” includes the plural reference unless the context clearly indicates otherwise. Numeric ranges are inclusive of the numbers defining the range.

In the present invention, a curable composition comprising an organic metal compound as a crosslinker, a method for increasing cross-linking density of a curable composition, the use of the organic metal compound as a crosslinker, and the article produced by using the said curable composition are disclosed. The curable composition may include but not limited to, a die attach adhesive or an underfill encapsulant and the like. The article may include but not limited to, a semiconductor device.

In an aspect of the present invention, there is provided a curable composition comprising at least a resin and an organic metal compound as a crosslinker.

### Organic Metal Compound

The organic metal compound may be selected from the group consisting of organic titanium compounds, organic aluminum compounds, organic zirconium compounds and combinations thereof.

In one embodiment, the organic titanium compound is an organic titanate. In some embodiments, the organic titanate is selected from the group consisting of tetraalkyl titanates, and titanate chelates. Tetraalkyl titanates can be represented by the general structure Ti(OR)4, wherein R represents an alkyl group, such as propyl, butyl, isooctyl, or the like. In some embodiments, the tetraalkyl titanates include tetraisopropyl titanate with molecular formula Ti(OC3H7)4; tetra-n-butyl titanate with molecular formula Ti(OC4H9)4; and

tetrakis(2-ethylhexyl)titanate with the molecular structure:

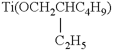

(e.g., Tyzor TOT from DuPont Co.). In other embodiments, the representative tetraalkyl titanates include isopropyl trioleic titanate,
titanium tris(dodecylbenzenesulfonate)isopropoxide,
titanium tristearoylisopropoxide,
bis(pentane-2,4-dionato-O,O′)bis(alkanolato)titanium,
bis(pentane-2,4-dionato-O,O′)bis(alkanolato)titanium,
bis(pentane-2,4-dionato-O,O′)bis(alkanolato)titanium,
triethanolamine Titanate, diisobutoxy-bis ethylacetoacetato titanate, and
tetrakis(2-ethylhexane-1,3-diolato) titanium.

Titanate chelates that may be used in the present invention may be represented by the formula

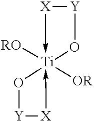

In this molecular structure, X represents a functional group containing oxygen or nitrogen, and Y represents a two- or three-carbon chain. Exemplary titanate chelates include without limitation, TYZOR® AA-series—acetylacetonate titanate chelate,

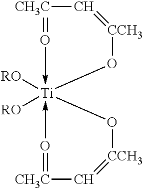

(e.g., Tyzor GBA from DuPont Co.);
TYZOR® DC—ethyl acetoacetate titanate chelate

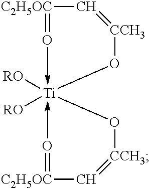

TYZOR® TE, triethanolamine titanate chelate, a mixture of chelates with at least one component that has the following cage structure:

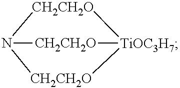

TYZOR® LA—lactic acid titanate chelate, ammonium salt

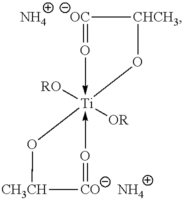

all of which may be commercially available from DuPont.

In some aspects, the crosslinker used in the present invention may be an aluminate and/or a zirconate. Exemplary aluminates include without limitation, distearoyl isopropoxy aluminate. Exemplary zirconates include without limitation, tetra-n-propyl zirconate, tetrakis(triethanloamino)zirconium(IV), sodium zirconium lactate, zirconium tetra-n-butanolate, and bis-citric acid diethyl ester n-propanolate zirconium chelate.

Typically, the total loading of one or more of the organic metal compounds may fall into the range from about 0.1 wt % to about 15 wt %, preferably from about 0.5 wt % to about 10 wt %, more preferably from about 1.0 wt % to about 6.0 wt %, and even more preferably from about 2 wt % to about 4 wt %, based on the total weight of the curable composition. In one aspect, the total loading of the organic metal compounds may be 1 wt %, 2 wt %, 4 wt %, 5 wt % or 8 wt % by weight of the curable composition.

### Resin

The resin used in the present invention may be any resin, including without limitation, one or more epoxy, acrylic ester, methacrylic ester, maleimide, vinyl ether, vinyl, cyanate ester, or siloxane resin and the like.

Exemplary epoxy resins include, for example, those selected from such as, liquid epoxy, liquid epoxy combination with different kinds of liquid epoxy, and solid epoxy in solution. The epoxy may also have additional functionality, for example, such as those substituted with amine or hydroxyl groups. The epoxy may also be unsubstituted, such as, 1,2-epoxypropane, 1,3-epoxypropane, butylene oxide, n-hexyl propylene epoxide or the like. Examples of commercially available epoxy resin include Epon™ Resin 862, Epiclon N-730A, Epiclon 830S (Resolution Performance Products, P.O. Box 4500, Houston, Tex. 77210, USA.); D.E.R.TM332 (The Dow Chemical Company, Midland, Mich. 48674); Araldite GY285 (Chemica Inc. 316 West 130th Street, Los Angeles, Calif., 90061, USA); RSL-1739 (P Bisphenol F/epichlorohydrin epoxy resin, from Resolution Performance Products); and NSC Epoxy 5320 (1,4-butanedioldiglycidyl ether, from Henkel Corporation.

Exemplary acrylic ester or methacrylic ester compounds include but are not limited to, liquid (meth)acrylate, liquid (meth)acrylates combination with, different kinds of acrylates and solid (meth)acrylate (monomer or oligomer) in solution. Specific examples include, methyl acrylate, ethyl acrylate, propylacrylate, isopropyl acrylate, n-butyl acrylate, isobutyl acrylate, t-butyl acrylate, amyl acrylate, isoamyl acrylate, hexyl acrylate, heptyl acrylate, octyl acrylate, 2-ethylhexyl acrylate, nonyl acrylate, decyl acrylate, isodecyl acrylate, laurylacrylate, tridecyl acrylate, hexadecyl acrylate, stearylacrylate, isostearyl acrylate, cyclohexyl acrylate, isobornyl acrylate, 2-hydroxyethyl acrylate, 2-hydroxypropyl acrylate, 2-hydroxy butyl acrylate, 4-hydroxy butyl acrylate, diethylene-glycol acrylate, polyethylene-glycol acrylate, polypropylene-glycol acrylate, 2-methoxy ethyl acrylate, 2-ethoxyethyl acrylate, 2-butoxy ethyl acrylate, methoxy diethylene-glycol acrylate, methoxy polyethylene-glycol acrylate, 2-phenoxy ethyl acrylate, methyl methacrylate, ethyl methacrylate, propyl methacrylate, isopropyl methacrylate, n-butyl methacrylate, isobutyl methacrylate, t-butyl methacrylate, amyl methacrylate, isoamyl methacrylate, hexyl methacrylate, heptyl methacrylate, octyl methacrylate, 2-ethylhexyl methacrylate, nonyl methacrylate, isodecyl methacrylate, lauryl methacrylate, tridecyl methacrylate, hexadecyl methacrylate, stearyl methacrylate, isostearyl methacrylate, cyclohexyl methacrylate, isobornyl methacrylate, 2-hydroxyethyl methacrylate, 2-hydroxypropyl methacrylate, 2-hydroxy butyl methacrylate, 4-hydroxy butyl methacrylate, dimer diol mono-methacrylate, diethylene-glycol methacrylate, polyethylene-glycol methacrylate, polypropylene-glycol methacrylate, 2-methoxy ethyl methacrylate, 2-ethoxyethyl methacrylate, 2-butoxyethylmethacrylate, methoxy diethylene-glycol methacrylate, methoxy polyethylene-glycol methacrylate, 2-phenoxy ethyl methacrylate, phenoxy diethylene-glycol methacrylate, phenoxy polyethylene-glycol methacrylate, 2-benzoyloxy ethyl methacrylate, and 2-hydroxy-3-phenoxy propyl methacrylate. Examples of commercially available acrylic ester or methacrylic ester compound include SR506 (isobornyl acrylate), SR9020 (propoxylated glyceryl triacrylate) (Sartomer Inc. (Shanghai), 500 Fu Te 2nd East Road, Wai Gao Qiao Free Trade Zone, Shanghai, 200131), SR368 (tris(2-hydroxy ethyl) isocyanurate triacrylate, from Sartomer), CN120Z (epoxy acrylate, from Sartomer) and SR306 (tripropylene glycol diacrylate, from Sartomer).

Exemplary cyanate ester resins used in the present invention include various suitable cyanate esters known in the art, for example, ethylene diisocyanate; 1,4-tetramethylene diisocyanate; 1,4 and/or 1,6-hexamethylene diisocyanate; 1,12-dodecane diisocyanate; cyclobutane-1,3-diisocyanate; cyclohexane-1,3- and 1,4-diisocyanate and mixtures of these isomers; 1-isocyanato-3,3,5-trimethyl-5-isocyanatomethyl cyclohexane; 2,4- and 2,6-hexahydrotolylene diisocyanate and mixtures of these isomers; hexahydro-1,3- and/or 1,4-phenylene diisocyanate; perhydro-2,4′- and/or 4,4′-diphenyl methane diisocyanate; 1,3- and 1,4-phenylene diisocyanate; 2,4- and 2,6-toluene diisocyanate and mixtures of these isomers; diphenyl methane-2,4′- and/or 4,4′-diisocyanate; naphthylene-1,5-diisocyanate; 1,3- and 1,4-xylylene diisocyanate, 4,4′-methylene-bis(cyclohexyl isocyanate), 4,4′-isopropyl-bis(cyclohexyl isocyanate), 1,4-cyclohexyl diisocyanate and 3-isocyanatomethyl-3,5,5-trimethylcyclohexyl isocyanate (IPDI); 2,4- and 2,6-toluene diisocyanate; diphenylmethane diisocyanate; hexamethylene diisocyanate; dicyclohexylmethane diisocyanate; isophorone diisocyanate; 1-methyoxy-2,4-phenylene diisocyanate; 1-chlorophenyl-2,4-diisocyanate; p-(1-isocyanatoethyl)-phenyl isocyanate; m-(3-isocyanatobutyl)-phenyl isocyanate and 4-(2-isocyanate-cyclohexyl-methyl)-phenyl isocyanate, isophorone diisocyanate, toluene diisocyanate and mixtures thereof.

Exemplary siloxane resins include non-functional silanes and functionalized silanes, including amino-functional, epoxy-functional, acrylate-functional and other functional silanes, which are known in the art, for example r-glycidoxypropyl-trimethoxysilane, γ-glycidoxypropyltriethoxysilane, glycidoxypropyltriethoxysilane, r-glycidoxypropyl-methyldiethoxysilane, glycidoxypropyltrimethoxysilane, glycidoxypropylmethyldimethoxysilane, glycidoxypropylmethyldiethoxysilane, 5,6-epoxyhexyltriethoxysilane, epoxycyclohexylethyltrimethoxysilane, trimethoxysilylpropyldiethylene-triamine, N-methylaminopropyltrimethoxysilane, aminoethylaminopropylmethyldimethoxysilane, aminoethylaminopropyltrimethoxysilane, aminopropylmethyldimethoxysilane, aminopropyltrimethoxysilane, aminoethylaminoethylaminopropyl-trimethoxysilane, N-methylamino-propyltrimethoxysilane, methylamino-propyltrimethoxysilane, aminopropylmethyl-diethoxysilane, aminopropyltriethoxysilane, 4-aminobutyltriethoxysilane, oligomeric aminoalkylsilane, m-aminophenyltrimethoxysilane, phenylaminopropyltrimethoxysilane, aminoethylaminopropyltriethoxysilane, aminoethylaminoisobutylmethyldimethoxysilane, (3-acryloxypropyl)-trimethoxysilane, gamma-methacryloxypropyltrimethoxysilane, gamma-mercapto-propyltriethoxysilane, and olefinic silanes, such as vinyltrialkoxysilane, vinyltriacetoxysilane, alkylvinyldialkoxysilane, allyltrialkoxysilane, hexenyltrialkoxysilane and the like.

Other resins may also be used in the present invention, for example, Epiclon EXA-830CRP (epichlorohydrin phenolformaldehyde resin, from Dinippon Ink & Chemicals Inc.), SRM-1 (C36 branched alkane diyl bis-[6-(2,5-dihydro-2,5-dioxo-1′-1-pyrol-1-yl)hexanoate], from Henkel Corporation), and the like.

Typically, the total loading of one or more of the resins may fall into the range from about 10-85 wt %, preferably about 20-70 wt %, and more preferably about 20-50 wt %, based on the total weight of the curable composition.

### Filler

The curable composition may further comprise filler. The fillers used in the practice of the present invention may include, but are not limited to organic and inorganic filler, electrical conductive or insulative as needed, such as gold, silver, copper, nickel, iron, alloys of these; copper, nickel, iron, glass, silica, aluminum, or stainless steel coated with gold, silver, or copper; aluminum, stainless steel; silica, glass, silicon carbide, boron nitride, aluminum oxide, boric-acid aluminum, aluminum nitride, oxide filler, and metal coated oxide filler and the like. Specific examples of commercially available fillers includes Cab-O-Sil® TS-720 silica (from Silicon Dioxide), SP-10G silica (amorphous silica, from Fuso Chemical Co., Ltd.), SE-1 (silicon dioxide, amorphous, hexamethyldisilazane treated, from Gelest), etc.

Typically, the total loading of one or more of the fillers may be in a range from about 10 wt % to about 85 wt %, and more preferably from about 30 wt % to about 70 wt %, or from about 40 wt % to about 60 wt %, based on the total weight of the curable composition.

### Curing Agent

The curable composition may further comprise a curing agent. The curing agent used in the practice of the present invention may include, for example, Lewis acid, Lewis base, imidazole, anhydride, amine, amine adduct or the like, for example, 1-cyanoethyl-2-phenylimidazole, 2-phenylimidazole, 2-methylimidazole, 2-phenylimidazoline, 1-cyanoethyl-2-phenylimidazolium-trimellitate. Specific examples of curing agents may include Jeffamine D-2000 (polyoxypropylene diamine, from Huntsman Petrochemical Corporation), 2P4MZ (micronized to 10 microns, phenylmethylimidazole, from National Starch & Chemicals), EMI-24-CN (1-(2-cyanoethyl)-2-ethyl-4-methylimidazole, from Borregaad Synthesis), etc.

Typically, if present, the total loading of one or more of the curing agents may be in a range from about 0.1 wt % to about 10 wt %, and preferably from about 1 wt % to about 5 wt %, based on the total weight of the curable composition.

In addition, the curable composition may further comprise a diluent, such as NSC Epoxy 5320 (1,4-butanedioldiglycidyl ether, from National Starch & Chemicals).

In another aspect of the present invention, there is provided a method for increasing the crosslinking density in a curable composition, said method comprising adding an effective amount of one or more of organic metal compound(s) to the curable composition. As described above, the organic metal compound may be selected from the group consisting of organic titanium compound, organic aluminum compound, organic zirconium compound and combination thereof. The total amount of one or more of the organic metal compounds may in the range from about 0.1 wt % to about 15 wt %, preferably from about 0.5 wt % to about 10 wt %, more preferably from about 1.0 wt % to about 6.0 wt %, and still more preferably from about 2 wt % to about 4 wt %, based on the total weight of the curable composition. In one aspect, the total loading of the organic metal compounds may be 1 wt %, 2 wt %, 4 wt %, 5 wt % or 8 wt % by weight of the curable composition. The method may improve the storage modulus at elevated temperature of the curable composition without bringing significant increase of room temperature modulus.

In yet another aspect of the present invention, the present invention further provides a method for producing an article with a component bonded to a substrate, the method comprising applying the above-described curable composition onto at least a part of the substrate surface and the component, and bonding the component to the substrate surface. In some embodiments, the method further comprises a step of thermally curing the adhesive at a temperature above room temperature, the step being performed after contacting the substrate with the adhesive. In still another aspect, the component bonded to a substrate may be a semiconductor component, such as a die.

In another aspect of the present invention, there is provided an article produced by the above-described method, the article comprising a substrate, a component on the substrate and the said curable composition by which the component bonded to the substrate. The said component may be a semiconductor component.

In a further aspect of the present invention, there is provided the use of the organic metal compound as a crosslinker in a curable composition, for example, die attach adhesive, underfill, etc. As described above, the organic metal compound may be selected from the group consisting of organic titanium compound, organic aluminum compound, organic zirconium compound and combination thereof. The total amount of one or more of the organic metal compounds may in the range from about 0.1 wt % to about 15 wt %, preferably from about 0.5 wt % to about 10 wt %, more preferably from about 1.0 wt % to about 6.0 wt %, and still more preferably from about 2 wt % to about 4 wt %, based on the total weight of the curable composition. In one aspect, the total loading of the organic metal compounds may be 1 wt %, 2 wt %, 4 wt %, 5 wt % or 8 wt % by weight of the curable composition.

The invention will now be further described with reference to the following non-limiting examples.

### EXAMPLES

### DMTA (Dynamic Mechanical Thermal Analysis) Test Method

Make sure the instrument (Dynamic Mechanical Analyzer Q800, from TA Instruments) is fully prepared and that the air bearing and cooling gases have been connected.

Choose, install, and calibrate the clamp appropriate for the sample shape and modulus range.

Measure the sample dimensions and load the sample into the clamp.

Position the thermocouple near the sample.

Select the mode of operation (DMA mulitifrequency, DMA multistrain, DMA controlled force, etc.) needed to perform the desired type of experiment.

Create a procedure that is appropriate to the operating mode, including force, frequency, heating rate, etc., as defined by the mode and the clamp type. (Include frequency or amplitude tables when appropriate.) Preprogrammed test templates are available if wishing to use them for your experiments.

Follow this general guideline when using the film clamp:

Set up the experiment parameters. Note that these clamps are tensioning clamp; therefore, force track and preload force values must be selected. The recommended values are 0.005 to IN for preload force and 115 to 200 percent for force track, if appropriate.
Amplitude: This signal should achieve and maintain the value programmed. If running a multistrain experiment, the amplitude will cycle through the values programmed.
Stiffness: The stiffness should be within the instrument's measurable range of 100N/m to 10000000N/m.
Drive Force The drive force should be between 0.0001 and 18N.
A normal run is performed from −65° C. to 250° C. at 3° C./min.
Then press MEASURE to start the motor, preview the desired measurement, and confirm that conditions are acceptable before continuing with the experiment.

Close the furnace and start the experiment. Before starting the experiment, ensure that the DMA is connected with the controller, the sample is loaded, the furnace is closed, and all necessary information have been entered through the instrument control software.

When having finished running experiments on the instrument, have a collection of data files. To analyze the information contained in these data files, use the TA Instruments Universal Analysis program. Calculate the modulus of elasticity at −65° C. and 25° C., and any other temperatures as needed.

### Example 1

### Preparation of the Curable Composition

Two groups of formulations, shown in Table 1 and Table 2, were prepared all based on epoxy resin according to the following procedure:

For Group 1 epoxy based formulations, add all raw materials in a jar following the sequence listed in Table 1. For example, if weighing 2.807 g RSL-1739, 0.2 g Jeffamine D-2000, 0.108 g Cab-O-Sil TS-720 silica, 0.2 g 2P4MZ curing agent, 5 g SP-10G silica, 0.913 g NSC EPOXY 5320, and 0.05 g EMI-24-CN, 9.278 g Exp1 sample will be obtained. Hand mix the compound in fume hood for 5 minutes, use spatula to guide the materials flow, and pay attention to jar corners, jar walls to mix well. Then let the material go through twice three-roll milling with in feed gap 2 mil, out feed gap 1.5 mil. The three roll mill used was EXAKT 50 from EXAKT Apparatebau GmBH & Co. kG, Robert-Koch-Strasse 5, 22851 Norderstedt, Germany. Hand mix for 5 minutes until a homogenous mixture is obtained.

For Group 2 epoxy based formulations, add all raw materials in a jar following the sequence listed in Table 2. For example, if weighting 3.6 g Epiclon EXA-830CRP, 0.3 g Jeffamine D-2000, 0.2 g 2P4MZ, 5.1 g SP-10G silica, 0.6 g NSC Epoxy 5320, 0.1 g Tyzor TOT and 0.4 g Tyzor GBA, 10.3 g Exp10 sample will be obtained. Hand mix the compound in fume hood for 5 minutes, use spatula to guide the materials flow, and pay attention to jar corners, jar walls to mix well. Then let the material go through twice three roll milling with in feed gap 2 mil, out feed gap 1.5 mil. Hand mix for 5 minutes until a homogenous mixture is obtained.

TABLE 1
Epoxy Based Formulation Group1

| Name of raw material | Exp1 | Exp2 | Exp3 | Exp4 | Exp5 |
|---|---|---|---|---|---|
| Test viehcle | TV1 | TV1 | TV1 | TV1 | TV1 |
| RSL-1739 | 28.07 | 28.07 | 28.07 | 28.07 | 28.07 |
| Jeffamine D-2000 | 2 | 2 | 2 | 2 | 2 |
| Cab-O-Sil TS-720 silica | 1.08 | 1.08 | 1.08 | 1.08 | 1.08 |
| 2P4MZ, Micronized to | 2 | 2 | 2 | 2 | 2 |
| 10 Microns | | | | | |
| SP-10G silica | 50 | 50 | 50 | 50 | 50 |
| NSC Epoxy 5320 | 9.13 | 9.13 | 9.13 | 9.13 | 9.13 |
| EMI-24-CN | 0.5 | 0.5 | 0.5 | 0.5 | 0.5 |
| Tyzor TOT | | 2 | 4 | | |
| Tyzor GBA | | | | 2 | 4 |
| Sum | 92.78 | 94.78 | 96.78 | 94.78 | 96.78 |

TV: test vehicle

TABLE 2
Epoxy Based Formulation Group2

| Name of raw material | Exp6 | Exp7 | Exp8 | Exp9 | Exp10 | Exp11 |
|---|---|---|---|---|---|---|
| Test viehcle | TV2 | TV2 | TV2 | TV2 | TV2 | TV2 |
| Epiclon EXA-830CRP | 36 | 36 | 36 | 36 | 36 | 36 |
| Jeffamine D-2000 | 3 | 3 | 3 | 3 | 3 | 3 |
| 2P4MZ, Micronized to | 2 | 2 | 2 | 2 | 2 | 2 |
| 10 Microns | | | | | | |
| SP-10G silica | 51 | 51 | 51 | 51 | 51 | 51 |
| NSC Epoxy 5320 | 6 | 6 | 6 | 6 | 6 | 6 |
| Tyzor TOT | | | | 1 | 1 | |
| Tyzor GBA | | 2 | 4 | 1 | 4 | 8 |
| Sum | 98 | 100 | 102 | 100 | 103 | 106 |

### DMTA Results of the Curable Compositions

DMTA results of the curable compositions in two Groups are showed in Tables 3-4 below.

TABLE 3
DMTA results for Group1

| | Examples | | | | | | | | | |
|---|---|---|---|---|---|---|---|---|---|---|
| | Exp 1 | Exp 2 | | Exp 3 | | Exp 4 | | Exp 5 | | |
| | Tg | | | | | | | | | |
| | 128.1 | 128.7 | | 127.9 | | 134.4 | | 132.6 | | Avg. |
| | Storage | Storage | Modulus | Storage | Modulus | Storage | Modulus | Storage | Modulus | Modulus |
| Measured | modulus | modulus | increase | modulus | increase | modulus | increase | modulus | increase | increase |
| temparature | (Mpa) | (Mpa) | by % | (Mpa) | by % | (Mpa) | by % | (Mpa) | by % | by % |
| −65 C. | 8999.0 | 9392.0 | 4.4% | 8927.3 | −0.8% | 9378.3 | 4.2% | 9300.3 | 3.3% | 2.8% |
| 25 C. | 6483.7 | 6761.3 | 4.3% | 6329.0 | −2.4% | 6675.0 | 3.0% | 6720.0 | 3.6% | 2.1% |
| 100 C. | 3371.0 | 3706.0 | 9.9% | 3161.3 | −6.2% | 3852.7 | 14.3% | 3740.3 | 11.0% | 7.2% |
| 150 C. | 463.3 | 575.9 | 24.3% | 522.2 | 12.7% | 602.9 | 30.1% | 591.7 | 27.7% | 23.7% |
| 200 C. | 369.9 | 437.2 | 18.2% | 420.4 | 13.7% | 416.3 | 12.5% | 395.7 | 7.0% | 12.8% |
| 250 C. | 358.5 | 432.0 | 20.5% | 411.0 | 14.6% | 395.1 | 10.2% | 351.5 | −2.0% | 10.8% |

TABLE 4
DMTA results for Group2

| | Examples | | | | | | | | | | | |
|---|---|---|---|---|---|---|---|---|---|---|---|---|
| | Exp 6 | Exp 7 | | Exp 8 | | Exp 9 | | Exp 10 | | Exp 11 | | |
| | Tg | | | | | | | | | | | |
| | 130.3 | 139.2 | | 134.2 | | 135.8 | | 139.5 | | 139.7 | | Avg. |
| | Storage | Storage | Modulus | Storage | Modulus | Storage | Modulus | Storage | Modulus | Storage | Modulus | Modulus |
| Measured | modulus | modulus | increase | modulus | increase | modulus | increase | modulus | increase | modulus | increase | increase |
| temparature | (Mpa) | (Mpa) | by % | (Mpa) | by % | (Mpa) | by % | (Mpa) | by % | (Mpa) | by % | by % |
| −65 C. | 9342.0 | 9006.3 | −3.6% | 9139.3 | −2.2% | 9147.7 | −2.1% | 9345.3 | 0.0% | 9417.0 | 0.8% | −1.4% |
| 25 C. | 6720.0 | 6437.7 | −4.2% | 6526.0 | −2.9% | 6616.7 | −1.5% | 6750.3 | 0.5% | 6745.3 | 0.4% | −1.6% |
| 100 C. | 3836.3 | 4093.3 | 6.7% | 4083.0 | 6.4% | 4028.0 | 5.0% | 4177.7 | 8.9% | 4310.0 | 12.3% | 7.9% |
| 150 C. | 463.7 | 643.5 | 38.8% | 589.4 | 27.1% | 607.0 | 30.9% | 635.3 | 37.0% | 744.9 | 60.6% | 38.9% |
| 200 C. | 341.2 | 362.1 | 6.1% | 345.5 | 1.3% | 389.0 | 14.0% | 331.6 | −2.8% | 311.8 | −8.6% | 2.0% |
| 250 C. | 316.2 | 318.4 | 0.7% | 295.8 | −6.4% | 346.1 | 9.5% | 280.5 | −11.0% | 232.7 | −26.4% | −6.8% |

From Table 3 and Table 4, it can be seen that, both groups show the same trend, that is, with addition of tetrakis(2-ethylhexyl) titanate/acetylacetonate titanate chelate (Tyzor TOT/GBA) as crosslinker, storage modulus of examples increase significantly at elevated temperature, i.e., 100° C., 150° C., and 200° C., especially at 150° C., while storage modulus at low and room temperature remained minor changes. For Group 1 examples, storage modulus at 250° C. remains highly increased with addition of (tetrakis(2-ethylhexyl) titanate)/(acetylacetonate titanate chelate), while storage modulus of Group 2 examples at 250° C. decreased by 6.8% on average.

These results exactly meet the expectation on die attach material stated before, that is, a moderate modulus at room temperature with retention at high temperature. With this property, the material will exhibit high performance in reliability test, which is becoming more and more important for evaluating performance of semiconductor packages.

### Example 2

### Effect of the Amount of the Organic Metal Compound on DMTA Results of the Curable Compositions

The curable compositions were formulated as described in Example 1 except that the amount of the organic metal compound was varied. The DMTA results of the curable composition are shown in Tables 5 and 6.

Since storage modulus of examples increased most significantly at 100° C. and 150° C., only values at these two temperatures are summarized in tables below.

TABLE 5

| Example | Exp1 | Exp2 | Exp3 | Exp4 | Exp5 |
|---|---|---|---|---|---|
| TV1 | 92.78 | 92.78 | 92.78 | 92.78 | 92.78 |
| Tyzor TOT | / | 2 | 4 | / | / |
| Tyzor GBA | / | / | / | 2 | 4 |
| Total | 92.78 | 94.78 | 96.78 | 94.78 | 96.78 |
| Storage modulus increase | 0 | 9.9 | −6.2 | 14.3 | 11 |
| by % at 100° C. | | | | | |
| Storage modulus increase | 0 | 24.3 | 12.7 | 30.1 | 27.7 |
| by % at 150° C. | | | | | |

It can be seen that, for Group 1 examples, storage modulus increase does not correspond to increase of amount of tetrakis(2-ethylhexyl) titanate/acetylacetonate titanate chelate (Tyzor TOT/GBA), and has an optimized value for storage modulus increase.

TABLE 6

| Example | Exp6 | Exp7 | Exp8 | Exp9 | Exp10 | Exp11 |
|---|---|---|---|---|---|---|
| TV1 | 98 | 98 | 98 | 98 | 98 | 98 |
| Tyzor TOT | / | / | / | 1 | 1 | / |
| Tyzor GBA | / | 2 | 4 | 1 | 4 | 8 |
| Total | 98 | 100 | 102 | 100 | 103 | 106 |
| Storage modulus increase | 0 | 6.7 | 6.4 | 5.0 | 8.9 | 12.3 |
| by % at 100° C. | | | | | | |
| Storage modulus increase | 0 | 38.8 | 27.1 | 30.9 | 37.0 | 60.6 |
| by % at 150° C. | | | | | | |

It can be seen that, for Group 2 examples, storage modulus increase does not correspond to increase of amount of tetrakis(2-ethylhexyl) titanate/acetylacetonate titanate chelate (Tyzor TOT/GBA) either when its amount is low (<=1 wt. %) or medium (<=4 wt. %). But when amount of tetrakis(2-ethylhexyl) titanate/acetylacetonate titanate chelate is high (up to 8 wt. %), the storage modulus at elevated temperature increase sharply again (see Exp11).

These results show only small amount of tetrakis(2-ethylhexyl) titanate/acetylacetonate titanate chelate can improve modulus decrease at elevated temperature greatly. This feature may reduce the possibility of impact on other properties of die attach material with the addition of tetrakis(2-ethylhexyl) titanate/acetylacetonate titanate chelate. And if very high requirement on modulus retain at elevated temperature is needed, high dose of acetylacetonate titanate chelate can be added to meet the requirement.

### Example 3

### The Use of the Curable Composition for Die Attach

This example shows an article or a process of producing the article, the article comprising a semiconductor component bonded to a substrate by one of the resultant curable compositions prepared in the Example 1.

At least a part of the substrate surface is applied with the curable composition Exp2 in Table 1 in a coating thickness of 1-2 mm, and then a die is applied to the adhesive-coated substrate surface. The die is bonded to the substrate after the adhesive is cured at a temperature, for example, 120° C. for 20 minutes, 110° C. for 10 minutes, 150° C. for 30 minutes, and 180° C. for 50 minutes and so on.

Those skilled in the art readily appreciate that the present invention is well adapted to achieve the purposes and obtain the advantages mentioned, as well as those inherent herein. It will be readily apparent to one skilled in the art that varying substitutions and modifications may be made to the invention disclosed herein without departing from the scope and spirit of the invention.

What is claimed:

1. A curable composition comprising a resin and an organic metal compound as a crosslinker wherein the organic metal compound is selected from the group consisting of organic titanium compound, organic aluminum compound, organic zirconium compound and combinations thereof.

2. The curable composition as claimed in claim 1, wherein the organic titanium compound is selected from the group consisting of tetrakis(2-ethylhexyl)titanate, tetraisopropyl titanate, tetra-n-butyl titanate, acetylacetonate titanate chelate, ethyl acetoacetate titanate chelate, triethanolamine titanate chelate, lactic acid titanate chelate and combinations thereof.

3. The curable composition as claimed in claim 2, wherein the organic aluminum compound comprises distearoyl isopropoxy aluminate, and the organic zirconium compound comprises tetraalkyl zirconate, tetra-n-propyl zirconate, tetrakis(triethanloamino)zirconium(IV), sodium zirconium lactate, zirconium tetra-n-butanolate, and bis-citric acid diethyl ester n-propanolate zirconium chelate.

4. The curable composition of claim 1, wherein the crosslinker is present at an amount of from about 0.5 wt % to about 10 wt %, based on the total weight of the curable composition.

5. The curable composition of claim 1, wherein the resin is selected from one or more of an epoxy, acrylic ester, methacrylic ester, maleimide, vinyl ether, vinyl, cyanate ester, or siloxane resin.

6. A method for increasing the crosslinking density in a curable composition, the method comprising adding an effective amount of an organic metal compound as a crosslinker to the curable composition, wherein the organic metal compound is selected from the group consisting of organic titanium compound, organic aluminum compound, organic zirconium compound and combination thereof.

7. An article produced by using the curable composition as claimed in claim 1.
